(19) United States
(12) Patent Application Publication
(10) Pub. No.: US 2025/0174937 A1
(43) Pub. Date: May 29, 2025

(54) Connector Assembly

(71) Applicant: TE Connecitivity Japan G. K., Kawasaki-shi (JP)

(72) Inventor: Masaaki Saito, Kawasaki-shi (JP)

(73) Assignee: TE Connecitivity Japan G. K., Kawasaki-shi (JP)

(21) Appl. No.: 18/960,039

(22) Filed: Nov. 26, 2024

(30) Foreign Application Priority Data
Nov. 28, 2023 (JP) 2023-200997

(51) Int. Cl. H01R 13/627; H01R 13/621

(52) U.S. Cl. CPC H01R 13/6273; H01R 13/621; H01R 2201/10

(57) ABSTRACT

A connector assembly includes a first connector having a first outer housing and a second connector matable with the first connector. The second connector includes a second connector base portion having a second mating portion matable with the first outer housing. A first one of the first connector and the second connector base portion has a pair of lock elements and a second one of the first connector and the second connector base portion has a pair of hook elements. The first outer housing and the second connector base portion are connectable by a connecting element.

### CROSS-REFERENCE TO RELATED APPLICATION

This application claims the benefit of the filing date under 35 U.S.C. § 119(a)-(d) of Japanese Patent Application No. 2023-200997, filed on Nov. 28, 2023.

### FIELD OF THE INVENTION

The present disclosure relates to a connector assembly.

### BACKGROUND OF THE INVENTION

A connector assembly is conventionally used, for example, to supply electric power from a cable to a motor. This connector assembly includes a first connector configured to be connected to one end of the cable and a second connector configured to be connected to the first connector.

The first connector has an outer housing in which a first contact to be connected to the cable can be placed. In the second connector, a second contact configured to make contact with the first contact can be placed, and the second connector has a mating portion configured to be mated with the outer housing. Further, the first connector has a lock element on an outer surface of the outer housing, and the second connector has a hook element configured to catch the lock element. Catch and release of a catch mechanism composed of these two elements make it possible to connect and disconnect the first connector and the second connector to and from each other.

In the conventional aspect in which the aforementioned catch mechanism is used to connect the two connectors to each other, an extremely small clearance is needed to smoothly connect the connectors. However, the formation of this extremely small clearance might make it hard to suitably connect the two connectors to each other.

### SUMMARY OF THE INVENTION

A connector assembly includes a first connector having a first outer housing and a second connector matable with the first connector. The second connector includes a second connector base portion having a second mating portion matable with the first outer housing. A first one of the first connector and the second connector base portion has a pair of lock elements and a second one of the first connector and the second connector base portion has a pair of hook elements. The first outer housing and the second connector base portion are connectable by a connecting element.

### BRIEF DESCRIPTION OF THE DRAWINGS

Features of the present invention will become more apparent by describing in detail exemplary embodiments thereof with reference to the accompanying drawings, in which:

FIG. 1 is an isometric view schematically showing the connector assembly according to a first embodiment of the present disclosure (in a state of being connected to a motor);

FIG. 2A is an isometric view schematically showing the connector assembly according to the first embodiment of the present disclosure;

FIG. 2B is a top view schematically showing the connector assembly according to the first embodiment of the present disclosure;

FIG. 2C is a front view schematically showing the connector assembly according to the first embodiment of the present disclosure;

FIG. 2D is a rear view schematically showing the connector assembly according to the first embodiment of the present disclosure;

FIG. 2E is a side view schematically showing the connector assembly according to the first embodiment of the present disclosure;

FIG. 2F is a bottom view schematically showing the connector assembly according to the first embodiment of the present disclosure;

FIG. 3A is an isometric view schematically showing the second connector of the connector assembly according to the first embodiment of the present disclosure;

FIG. 3B is a top view schematically showing the second connector of the connector assembly according to the first embodiment of the present disclosure;

FIG. 3C is a bottom view schematically showing the second connector of the connector assembly according to the first embodiment of the present disclosure;

FIG. 3D is a schematic side view of the second connector of the connector assembly according to the first embodiment of the present disclosure as seen from a first side surface direction;

FIG. 3E is a schematic side view of the second connector of the connector assembly according to the first embodiment of the present disclosure as seen from a second side surface direction;

FIG. 4 is an exploded isometric view of the second connector of the connector assembly according to the first embodiment of the present disclosure;

FIG. 5A is an isometric view schematically showing the first connector of the connector assembly according to the first embodiment of the present disclosure;

FIG. 5B is a top view schematically showing the first connector of the connector assembly according to the first embodiment of the present disclosure;

FIG. 5C is a front view schematically showing the first connector of the connector assembly according to the first embodiment of the present disclosure;

FIG. 5D is a rear view schematically showing the first connector of the connector assembly according to the first embodiment of the present disclosure;

FIG. 5E is a side view schematically showing the first connector of the connector assembly according to the first embodiment of the present disclosure;

FIG. 5F is a bottom view schematically showing the first connector of the connector assembly according to the first embodiment of the present disclosure;

FIG. 6 is an exploded isometric view of the first connector of the connector assembly according to the first embodiment of the present disclosure;

FIG. 7 is an isometric view schematically showing the first connector of a connector assembly according to a second embodiment of the present disclosure;

FIG. 8A is an isometric view schematically showing the connector assembly according to a third embodiment of the present disclosure;

FIG. 8B is a top view schematically showing the connector assembly according to the third embodiment of the present disclosure;

FIG. 8C is a front view schematically showing the connector assembly according to the third embodiment of the present disclosure;

FIG. 8D is a rear view schematically showing the connector assembly according to the third embodiment of the present disclosure;

FIG. 8E is a side view schematically showing the connector assembly according to the third embodiment of the present disclosure; and

FIG. 8F is a bottom view schematically showing the connector assembly according to the third embodiment of the present disclosure.

### DETAILED DESCRIPTION

In the following, a connector assembly 500 according to a first embodiment of the present disclosure is described with reference to the drawings.

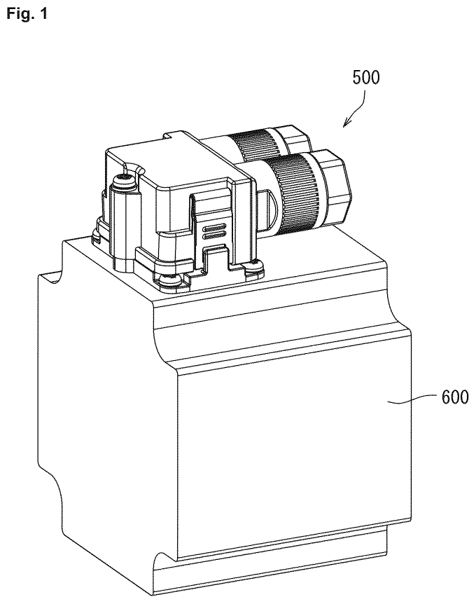

As shown in FIG. 1, the connector assembly 500 according to the first embodiment of the present disclosure can be attached and fixed to a device 600 such as a motor. One end of a cable is connected to the connector assembly 500 so that electric power can be supplied from the cable via the connector assembly 500 to the device 600 such as a motor. The “connector assembly” herein is equivalent to a combination of two or more connectors and can also be referred to as a “connector unit”.

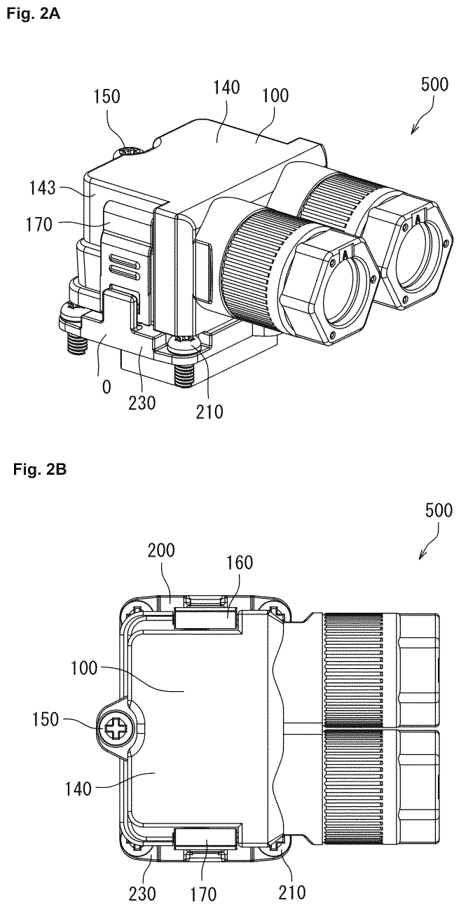

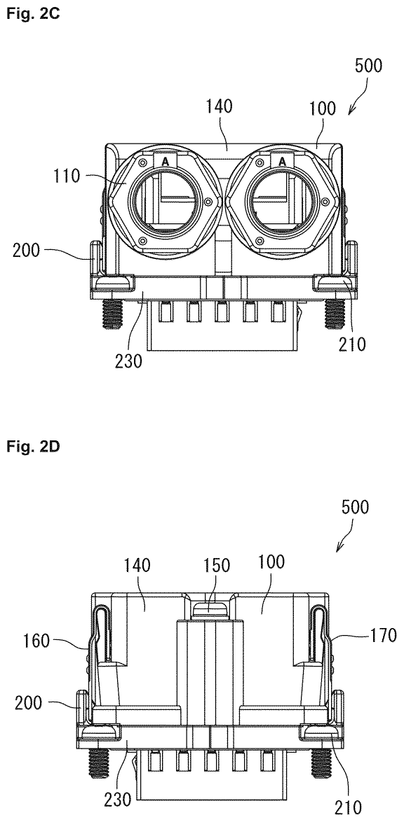

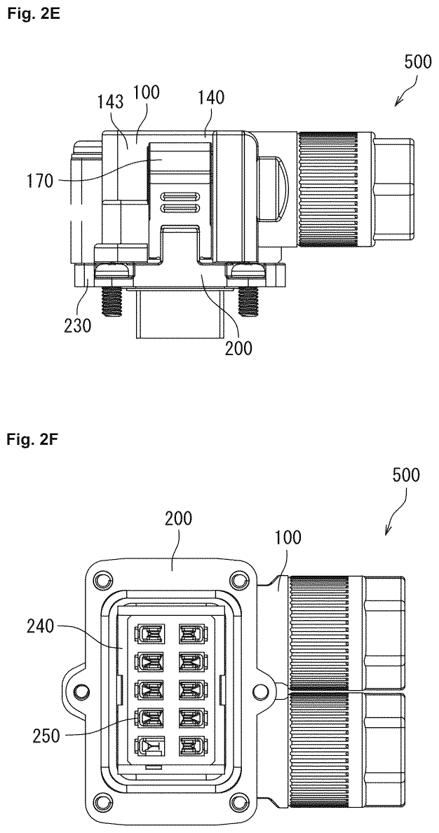

As shown in FIGS. 2A to 2F, the connector assembly 500 according to the first embodiment of the present disclosure includes a first connector 100 and a second connector 200. The first connector 100 can be configured to be connectable to one end of the cable. The first connector 100 and the second connector 200 can be integrally connected to each other by two types of connection mechanisms described in detail below and differing in connection form from each other.

The cable is exited in a horizontal direction (that is equivalent to a direction along a direction of extension of a long side of a casing of the device 600 (see FIG. 1) such as a motor to which the connector assembly 500 is attached).

### First Connector

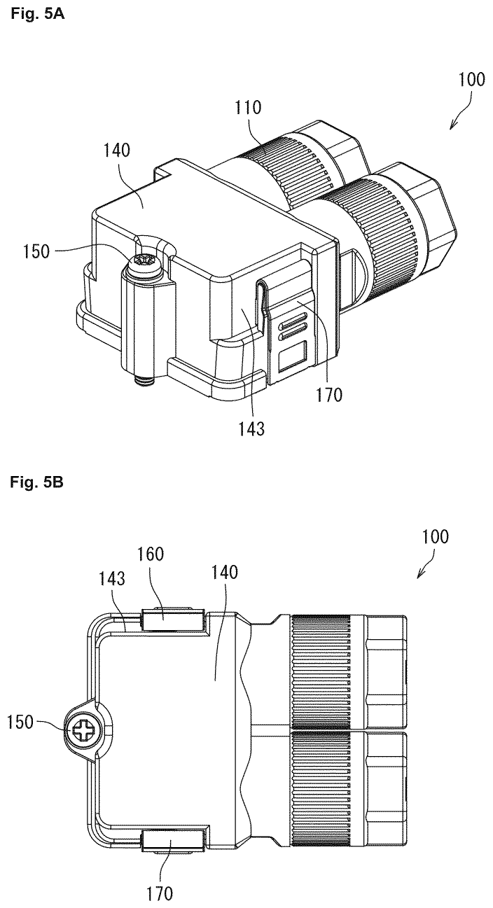

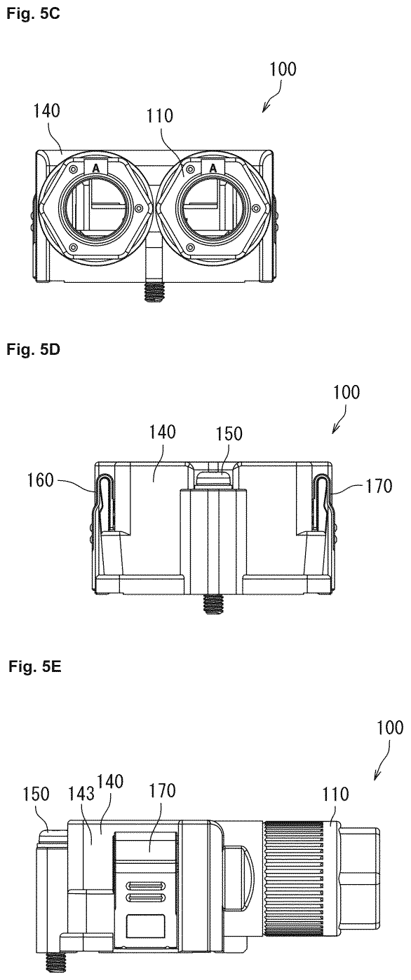

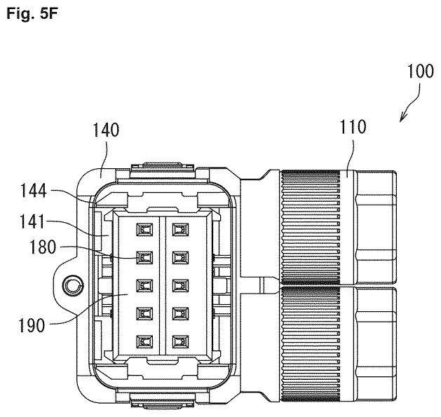

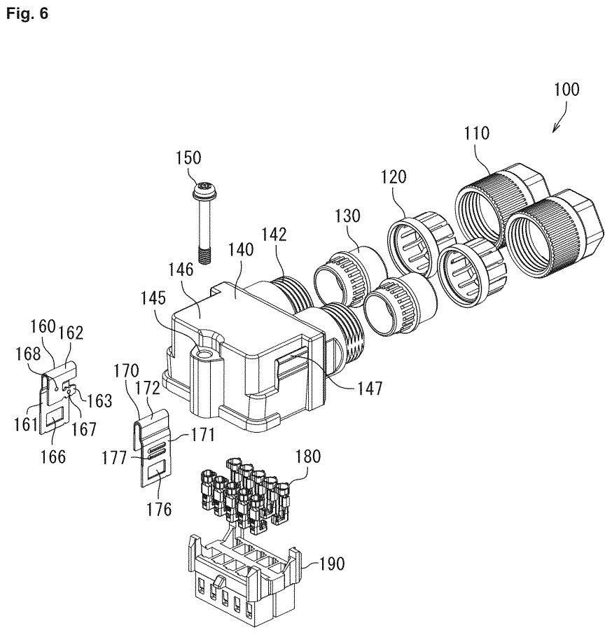

As shown in FIGS. 5A to 6, the first connector 100 includes a first outer housing 140 in which a first contact 180 configured to be connected to the cable can be placed.

In the shown embodiment, the first outer housing 140 has, in its main body portion 146, an inner space 141 (see FIG. 5F) having an opening in a side thereof that is connected to the second connector. In the inner space 141, an inner housing 190 configured to accommodate the first contact 180 can be placed and attached. Further, the first connector 100 has a pair of lock elements 160 and 170 attached to an outer surface 143 of the outer housing 140 so as to face each other.

The first outer housing 140 of the first connector 100 has a cylindrical portion 142 provided with a cable opening through which the cable is inserted, as shown in FIG. 6. The cylindrical portion 142 has a screw portion formed around an outer surface thereof. In addition to the first outer housing 140, the first connector 100 includes a cylindrical clamp rubber 130 (that functions as waterproof rubber) configured to be inserted onto an inner surface of the cylindrical portion 142, a cable clamp 120, and a cap 110 having, in an inner surface thereof, a screw portion configured to be connected to the screw portion formed around the outer surface of the cylindrical portion 142.

The cable is attached so as to pass through inside the clamp rubber 130, the cable clamp 120, and the cap 110, and is configured to be connected to the first contact 180 placed in the inner space 141 of the first outer housing 140.

Although the following description focuses on the lock element 160, the lock element 170, which is disposed to face the lock element 160, can be configured in a similar manner.

The lock element 160 has the shape of a plate spring as a whole and has a basal portion 161, a folded portion (or inward curve portion) 162, and a press-fit portion 163 that is press fitted into the first outer housing 141. The basal portion 161 extends in a direction of mating (up-down direction) of the two connectors and has, in a lower part thereof, a catching hole 166 that is responsible for catching the second connector 200.

The basal portion 161 has, on top of the catching hole 166, a projecting portion protruding further outward than the first connector 100 in the direction of plate thickness. This projecting portion serves to, when an operator pinches the lock element with his/her fingers from either side of the lock element, notify the operator of the position of the lock element by conveying the feel of the lock element to the fingers. The basal portion 161 can be placed on an outer wall provided at a predetermined spacing from the outer surface of the first outer housing 141.

The folded portion 162 can be latched onto a latch portion 147 provided at a predetermined spacing from the outer surface of the first outer housing 141. The folded portion 162 is a portion joined to an upper side of the basal portion 161, curved inward in a direction (upward) opposite to the direction of mating (downward), and oriented in the direction of mating (downward).

The press-fit portion 163 is a portion joined to a folded-back portion of the folded portion 162, extended in a direction intersecting the direction of mating (i.e., in a direction in which the cable can extend from the first connector 100), and press fitted into the first outer housing 141. Such a configuration allows the lock element 160 to keep a spring property as a plate spring as a whole and prevents an unintended force from being transmitted to the press-fit portion 163.

The press-fit portion 163 has a first protruding portion 167 protruding into the first connector 100 in the direction of plate thickness. The first protruding portion 167 can strongly interfere with the first outer housing 140 so as to penetrate or dig into the first outer housing 140. Further, the folded portion 162 of the lock element 160 has, in a portion thereof folded back in the direction of mating (downward), a second protruding portion 168 protruding into the first connector 100 in the direction of plate thickness. As with the first protruding portion 167, the second protruding portion 168 too can strongly interfere with the first outer housing 140 so as to penetrate or dig into the first outer housing 140.

The lock element 170 has a basal portion 171, a folded portion 172, and a catching hole 176.

### Second Connector

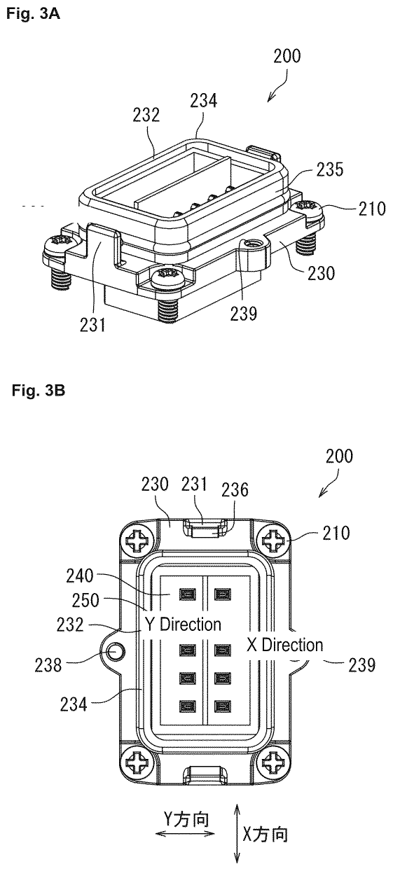

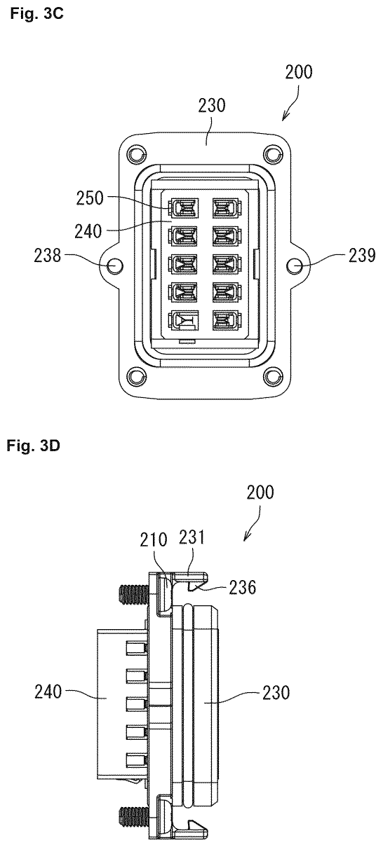

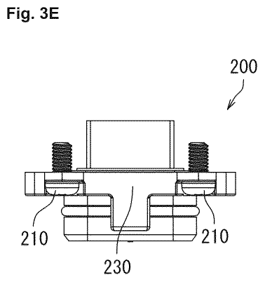

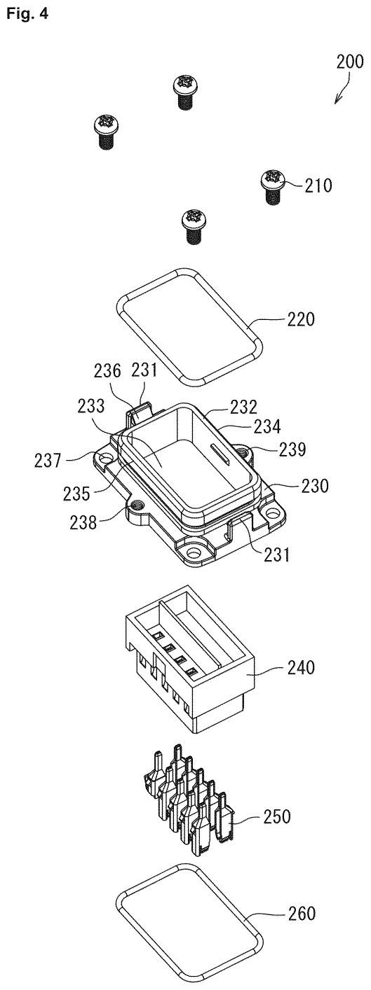

As shown in FIGS. 3A to 4, the second connector 200 includes a second connector base portion 230 in which a second contact 250 configured to make contact with the first contact 180 can be placed and that has a second mating portion 232 configured to be mated with the first outer housing 140. In the illustrated embodiment, the second contact 250 of the second connector 200 is a male contact, and the first contact 180 of the first connector 100 is a female contact. However, this is not intended to impose any limitation; the second contact 250 of the second connector 200 may be a female contact, and the first contact 180 of the first connector 100 may be a male contact.

Specifically, the second mating portion 232 of the second connector base portion 230 is configured to have an opening in a first side so that the second contact 250 can make contact with the first contact 180 and have an opening in a second side so that the second contact 250 can make contact with a contact within the device 600 (see FIG. 1) such as a motor. That is, as shown in FIG. 4, the second mating portion 232 has a through inner space 233.

In the inner space 233, an inner housing 240 configured to accommodate the second contact 250 can be placed and attached. Further, the second mating portion 232 has a surrounding portion 234 extending in the direction of mating of the two connectors. When the first outer housing 140 and the second mating portion 232 are mated with each other, an outer surface 235 of the surrounding portion 234 of the second mating portion and an inner surface 144 (see FIG. 5F) of the first outer housing 140 can be disposed to face each other.

The second connector base portion 230 has a pair of hook elements 231 positioned to face each other outside the second mating portion 232. Each hook element 231 has inside thereof a projecting portion 236 configured to catch the catching holes 166 and 176 of the lock elements 160 and 170 of the first connector 100.

Such a configuration allows the pair of lock elements 160 and 170 attached to the outer surface of the first outer housing 140 to be caught on the pair of hook elements 231 of the second connector base portion 230. The foregoing makes a mating connection of the first outer housing 140 to the second connector base portion 230 possible based on a catch mechanism using the pair of lock elements 160 and 170 and the pair of hook elements 231 of the second connector base portion 230. That is, a mating connection of the first connector 100 to the second connector 200 is made possible.

In order to improve the sealing performance with which the first outer housing 140 and the second mating portion 232 are mated with each other, the second connector 200 has a seal element 220 that can make contact with the surrounding portion 234 of the second mating portion and that can also make contact with the first outer housing 140. Further, in order to improve the sealing performance with which the second connector base portion 230 and the device 600 (see FIG. 1) such as a motor are connected to each other, the second connector 200 has a seal element 260 provided on a principal surface of the second connector base portion 230 opposite to the place of formation of the second mating portion 232.

Further, the second connector base portion 230 has a plurality of through holes 237, as shown in FIG. 4. In a case where the shape of the second connector base portion 230 is a rectangle in a plan view, these through holes 237 can be placed in corner portions of the second connector base portion 230. Connecting elements 210 such as screw elements are inserted into the through holes 237 so that finally, the second connector base portion 230, i.e., the second connector 200, and the device 600 (see FIG. 1) such as a motor can be connected to each other.

Note here that the connector assembly 500 of the present disclosure is characterized in that, as will be described below, the first outer housing 140 and the second connector base portion 230 are configured to be connected to each other by the connecting element 150 as well as a catch mechanism using the pair of lock elements 160 and 170 and the pair of hook elements 231 of the second connector base portion 230.

According to such a feature, the first outer housing 140 and the second connector base portion 230 are configured to be integrally connected to each other by interlock of the pair of lock elements 160 and 170 and the pair of hook elements 231 and an interconnection made by the connecting element 150. That is, in the present disclosure, the first outer housing 140 and the second connector base portion 230 are configured to be integrally connected to each other by two or more types of connection mechanism differing in connection form from each other.

As a result of this, even if an extremely small clearance is needed to smoothly connect the two connectors 100 and 200 to each other, the two connectors 100 and 200 can be more suitably connected to each other than in a case where the first outer housing 140 and the second connector base portion 230 are configured to be integrally connected to each other by interlock of the pair of lock elements 160 and 170 and the pair of hook elements 231.

The following aspect can be adopted as a specific aspect in which the first outer housing 140 and the second connector base portion 230 are connected to each other by the connecting element 150 (see, for example, FIGS. 4 and 6).

Specifically, the first outer housing 140 has a through hole 145 that is formed at an outer surface of the main body portion 146 and that extends in the direction of mating of the first connector 100 and the second connector 200. The number of through holes 145 may be, but is not particularly limited to, 1.

Further, the second connector base portion 230 has an opening-equipped space 238 (or 239) that extends in the direction of mating, that is formed outside the second mating portion 232, and that is configured to communicate with the through hole 145. In addition to that, in the present disclosure, the connecting element 150 is configured to be inserted in a state of communication between the through hole 145 of the first outer housing 140 and the opening-equipped space 238 (or 239) of the second connector base portion 230. This enables the first outer housing 140 and the second connector base portion 230 to be connected to each other by the connecting element 150. A usable example of the connecting element 150 is a screw element.

The opening-equipped space of the second connector base portion 230 does not necessarily need to take the form of a through hole in comparison with the through hole 145 of the first outer housing 140, provided the first outer housing 140 and the second connector base portion 230 are configured to be connected to each other by the connecting element 150. From the point of view of, for example, production efficiency, the opening-equipped space of the second connector base portion 230 too may take the form of a through hole.

The second connector base portion 230 may have a pair of opening-equipped spaces 238 and 239 placed opposite each other across the second mating portion 232. In addition to that, in the present disclosure, either a first one 238 of the opening-equipped spaces or a second one 239 of the opening-equipped spaces and the through hole 145 of the first outer housing 140 are configured to communicate with each other.

From the point of view of improvement in connection reliability in a portion in which the aforementioned catch mechanism is not placed, the pair of opening-equipped spaces 238 and 239 can be placed so that in the second connector base portion 230, a direction X in which the pair of hook elements 231 are placed opposite each other across the second mating portion 232 and a direction Y in which the pair of opening-equipped spaces 238 and 239 are placed intersect each other (see FIG. 3B), although this is not intended to impose any particular limitation. In a case where the shape of the second connector base portion 230 is a rectangle in a plan view, one of the hook elements 231, the opening-equipped space 238, the other of the hook elements 231, and the opening-equipped space 239 may be provided in this order on four consecutive sides.

Because the through hole 145 of the first outer housing 140 is configured to communicate with either the first opening-equipped space 238 or the second opening-equipped space 239, it is possible to provide two options for inserting the connecting element 150. On account of this, in a state where the second connector base portion 230 is connected to the device 600 (see FIG. 1) such as a motor, the position of the through hole 145 of the first outer housing 140 and the position of the first opening-equipped space 238 or the second opening-equipped space 239 are matched in consideration of, for example, a desired cable exit direction so that a direction in which the cable is exited from the first connector 100 is a predetermined horizontal direction or a direction opposite to the predetermined horizontal direction.

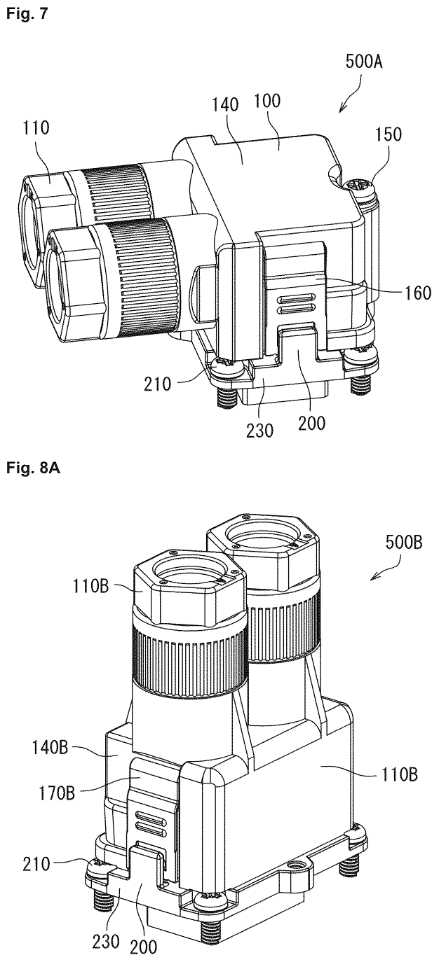

That is, in a case where the first connector 100 of an identical structure is used, it is possible to select a pattern in which the through hole 145 of the first outer housing 140 is made to communicate with either the first opening-equipped space 238 or the second opening-equipped space 239. This makes it possible to, by simply changing the placement of the first connector 100 of an identical structure, provide two patterns of exit of the cable in a horizontal direction (see FIGS. 2A and 7). This makes it possible to increase the degree of freedom of exit of the cable in a horizontal direction with a simple method in the embodiments described with reference to FIGS. 1 to 7. The connector assembly in FIG. 7 is a connector assembly 500A.

In a pattern in which the cable is exited in a horizontal direction, a direction in which the cable is exited from the first connector 100 and a direction of insertion of the connecting element 150 can be different from each other. In other words, the direction in which the cable is exited from the first connector 100 and the direction of mating of the two connectors can be different from each other. For example, the direction in which the cable is exited and the direction of insertion of the connecting element 150 (or the direction of mating of the two connectors) intersect each other or, in an embodiment, perpendicularly intersect each other.

In the embodiments described with reference to FIGS. 1 to 7, for example, the first contact, the second contact, the lock elements, the connecting element (such as a screw element) can be made of metal. Meanwhile, the constituent elements of the first connector 100 and the second connector 200 other than these can be made of resin. Without being limited to this, the outer housing of the connector can be made of resin and/or metal.

Further, the illustrated exemplary aspect is based on a case in which two caps 110 attached to the first outer housing 140 are arranged adjacent and parallel to each other. However, without being limited to this, the number of caps 110 may be one or may be three or greater.

As mentioned above, the connector assembly of the present disclosure is used to ensure an electrical pathway between the cable and the device. In a case where two or more electrical pathways are needed, the connector assembly of the present disclosure may be used to ensure, between the cable and the device such as a motor, (1) an electrical pathway for supplying the device with a power supply voltage for driving or controlling the device and (2) an electrical pathway for transmission of a signal from a sensor (that is equivalent to an encoder) configured to detect, for example, rotation information of the device. In some cases, furthermore, the connector assembly of the present disclosure may be used to ensure (3) an electrical pathway for transmission of a signal to a component (that is equivalent to a brake) for deactivating the device.

In this case, the number of inner housings 240 that are attached to the inside of the inner space 233 of the second connector base portion 230, the placement pattern of the second contact used in ensuring two or more electrical pathways, or other conditions can be adjusted as appropriate. Similarly, the number of inner housings 190 that are attached to the inside of the inner space 141 (see FIG. 5F) of the first outer housing 140, the placement pattern of the first contact, which is configured to make contact with the second contact, used in ensuring two or more electrical pathways, or other conditions be adjusted as appropriate.

Further, one cable that is electrically connected to the device such as a motor may include two or more inner cables. Each inner cable can be composed of a conducting wire such as a pure copper wire or a tin-plated copper wire and an insulative inner cable coating covering an outer surface of this conducting wire. Moreover, a front end of this inner cable and a contact that is accommodated in an inner housing of a connector can be connected to each other.

In one example, as exemplarily illustrated in the present disclosure, an aspect in which two or more cables can be connected as a whole can be adopted. In this case, for example, the first cable includes a first inner cable bundle composed of a plurality of first inner cables of the same type, a conductive cable shield enclosing the first inner cable bundle, and an insulative coating clement enclosing the cable shield. Further, the second cable includes a second inner cable bundle composed of second inner cables of different type, a conductive cable shield enclosing the second inner cable bundle, and an insulative coating element enclosing the cable shield. For example, the insulative covering elements enclosing the cable shields can be formed from polyvinyl chloride (PVC), polypropylene, a fluoropolymer, polyethylene, and/or polymer of the same type as those.

In another example, one composite cable having inner cables of different types inside as a whole can be used. In an example of a case where one composite cable having first and second inner cables of different types inside, an outer surface of the composite cable having these inner cables inside can be constituted by a conductive cable shield and an insulative coating element enclosing this cable shield. Note that while a plurality of inner cables of the same type are bundled into one, first and second inner cables of different types are further separated by a conductive cable shield and an insulative coating element enclosing this cable shield.

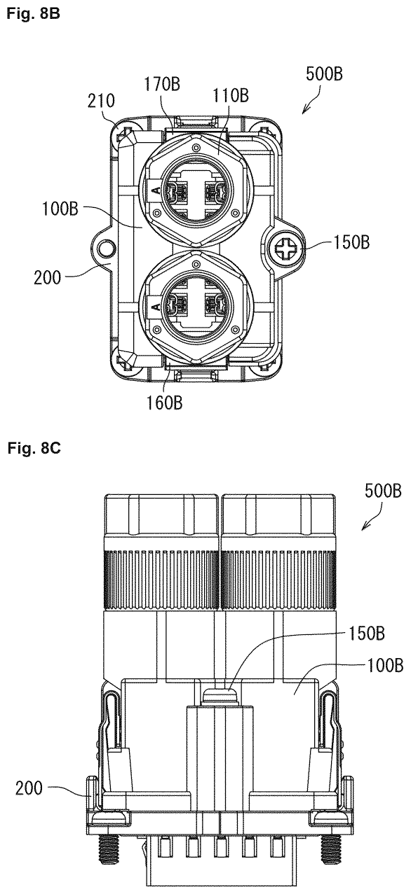

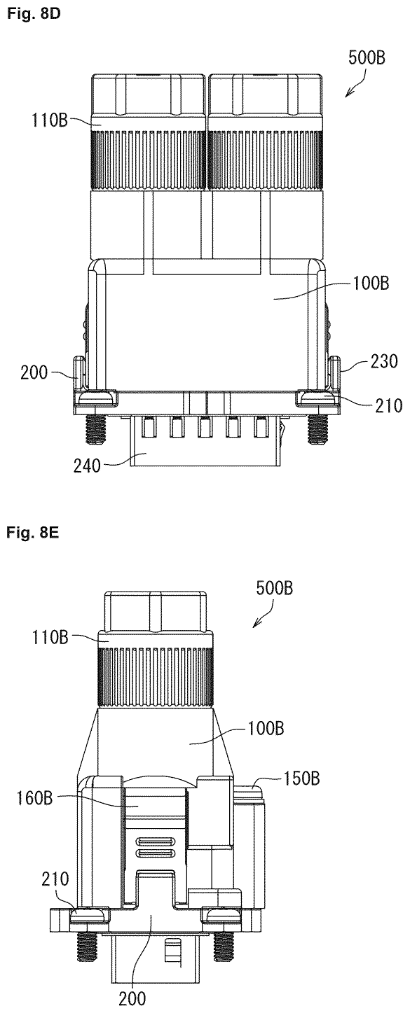

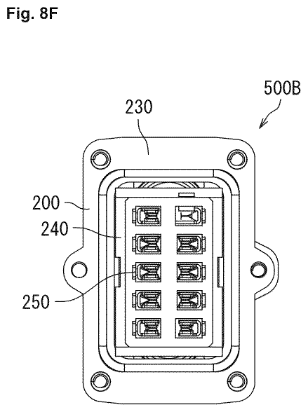

In the following, a third embodiment of the present disclosure is described with reference to FIGS. 8A to 8F. From the point of view of avoiding overlapped description, this embodiment is described with a focus on points of difference from the embodiments described with reference to FIGS. 1 to 7.

The embodiments described with reference to FIGS. 8A to 8F differs from the embodiments described with reference to FIGS. 1 to 7 in using a first connector of a different structure configured such that a direction in which a cable is exited is a vertical direction. In this case, as shown in FIGS. 8B, 8C, and 8E, a direction in which the cable is exited from the first connector 100B and a direction of insertion of a connecting element 150B can be substantially identical to each other. In other words, the direction in which the cable is exited from the first connector 100B and the direction of mating of the two connectors can be substantially identical to each other. The embodiments of FIGS. 8A to 8F form a connector assembly 500B. The lock elements in the embodiment of FIGS. 8A to 8F are lock elements 160B and 170B.

Further, in the embodiments described with reference to FIGS. 1 to 7, the cylindrical portion 142 (i.e. a cylindrical portion provided with a cable opening into which the cable is inserted) of the first outer housing 140 or the cap 110 (see FIG. 6) attached to the cylindrical portion 142 can be located above one of the two opening-equipped spaces of the second connector base portion 230, as the cable can be exited in a horizontal direction.

In an embodiment, two of these cylindrical portions 142 or caps 110 are arranged adjacent and parallel to each other. Because of such a structure, in addition to the two catch points based on the catch mechanism, the number of points of connection at which the first outer housing 140 and the second connector base portion 230 are connected by the connecting element (such as a screw element) can be 1.

Meanwhile, in the embodiment described with reference to FIGS. 8A to 8F, it becomes possible that a cylindrical portion of a first outer housing 140B or a cap 110B attached to the cylindrical portion are not located above either of the two opening-equipped spaces of the second connector base portion 230, as the cable can be exited in a vertical direction.

Because of such a structure, the number of points of connection between the first outer housing 140B and the second connector base portion 230 by the connecting element 150B can be made two in addition to the two catch points based on the catch mechanism by making an adjustment to avoid interference between an outer surface of the first outer housing 140B and the connecting element 150B (such as a screw element).

As noted above, in the embodiment described with reference to FIGS. 8A to 8F, in which the number of points of connection between the first outer housing 140B and the second connector base portion 230 by the connecting element 150B is 2, the two connectors 100B and 200 can be even more suitably connected to each other than in the embodiments described with reference to FIGS. 1 to 7, even if an extremely small clearance is needed to smoothly connect the two connectors 100B and 200 to each other.

A connector assembly of the present disclosure is used, for example, to supply electric power from a cable to a motor. A connector assembly of the present disclosure is not limited to the foregoing embodiments. Changes may be made as appropriate within the scope of the present disclosure.

1. A connector assembly, comprising:
a first connector including a first outer housing; and
a second connector matable with the first connector, the second connector including a second connector base portion having a second mating portion matable with the first outer housing, a first one of the first connector and the second connector base portion has a pair of lock elements and a second one of the first connector and the second connector base portion has a pair of hook elements, the first outer housing and the second connector base portion are connectable by a connecting element.

2. The connector assembly according to claim 1, wherein the first connector is connectable to an end of a cable, a first contact connectable to the cable is positioned in the first outer housing.

3. The connector assembly according to claim 2, wherein the second connector has a second contact in the second connector base portion, the second contact is connectable with the first contact.

4. The connector assembly according to claim 1, wherein the first outer housing and the second connector base portion are integrally connected to each other by interlock of the pair of lock elements and the pair of hook elements.

5. The connector assembly according to claim 4, wherein the first outer housing and the second connector base portion are integrally connected to each other by an interconnection made by the connecting element.

6. The connector assembly according to claim 1, wherein the first outer housing and the second connector base portion are integrally connected to each other by two or more types of connection mechanisms differing in connection form from each other.

7. The connector assembly according to claim 1, wherein the first outer housing has a through hole at an outer surface thereof, the through hole extends in a direction of mating of the first connector and the second connector.

8. The connector assembly according to claim 7, wherein the second connector base portion has an opening-equipped space that extends in the direction of mating, the opening-equipped space is formed outside the second mating portion and communicates with the through hole.

9. The connector assembly according to claim 8, wherein the connecting element is insertable into the through hole and the opening-equipped space.

10. The connector assembly according to claim 8, wherein the second connector base portion has a pair of opening-equipped spaces positioned opposite each other across the second mating portion.

11. The connector assembly according to claim 10, wherein either a first one of the opening-equipped spaces or a second one of the opening-equipped spaces communicates with the through hole of the first outer housing.

12. The connector assembly according to claim 11, wherein the first connector of an identical structure is used to select a pattern in which the through hole of the first outer housing communicates with either the first one of the opening-equipped spaces or the second one of the second opening-equipped spaces.

13. The connector assembly according to claim 11, wherein, in the second connector base portion, the pair of hook elements are placed opposite each other across the second mating portion.

14. The connector assembly according to claim 13, wherein a first direction in which the pair of hook elements are placed and a second direction in which the pair of opening-equipped spaces are placed intersect each other.

15. The connector assembly according to claim 1, wherein the pair of lock elements are attached to face each other on an outer surface of the first outer housing.

16. The connector assembly according to claim 15, wherein the pair of hook elements are positioned to face each other outside the second mating portion in the second connector base portion.

17. The connector assembly according to claim 9, wherein a direction in which a cable exits the first connector and a direction of insertion of the connecting element are different from each other.

18. The connector assembly according to claim 9, wherein a direction in which a cable exits the first connector and a direction of insertion of the connecting element are identical to each other.

19. The connector assembly according to claim 1, wherein the second connector base portion is connected to a motor.

20. The connector assembly according to claim 1, wherein the connecting element is a screw element.
